(19) United States
(12) Patent Application Publication
(10) Pub. No.: US 2024/0085202 A1
(43) Pub. Date: Mar. 14, 2024

(54) LOCATION BASED VEHICLE ELECTRIC RANGE CONTROL

(71) Applicant: FORD GLOBAL TECHNOLOGIES, LLC, Dearborn, MI (US)

(72) Inventors: Patrick SODERBORG, Dexter, MI (US); Wendy Lynn MACLENNAN, Northville, MI (US); Gregory ZIEMBA, Farmington Hills, MI (US); Kristian PALA, Troy, MI (US)

(21) Appl. No.: 17/941,874

(22) Filed: Sep. 9, 2022

(51) Int. Cl. G01C 21/34; B60W 10/30; B60W 50/14; G01C 21/36

(52) U.S. Cl. CPC G01C 21/3469; B60W 10/30; B60W 50/14; G01C 21/3605; B60W 2050/146

(57) ABSTRACT

A controller of a vehicle may limit power consumption of at least one accessory load during an upcoming trip responsive to a predicted electric travel range of the vehicle, that is based on an indication of a degree to which the vehicle is parked in a sheltered location, being less than a predicted distance for the trip.

### TECHNICAL FIELD

The present disclosure relates to estimating electric vehicle range and operating electric vehicles.

### BACKGROUND

Electric vehicles (EVs) are propelled via an electric motor using power stored in a traction battery. The weather's influence on the ambient temperature may play a role in the energy available from the traction battery. When the vehicle experiences a significant change in ambient temperature, the traction battery energy amount as well as the vehicle range may be affected.

### SUMMARY

A power system for a vehicle includes one or more controllers that limit power consumption of at least one accessory load during an upcoming trip responsive to a predicted electric travel range of the vehicle, that is based on an indication of a degree to which the vehicle is parked in a sheltered location, being less than a predicted distance for the trip.

A method for a vehicle includes, while the vehicle is parked and unplugged, selectively generating a command for a user to plug in the vehicle based on an indication of whether the vehicle is located in a shaded area.

A vehicle includes an electric machine, a traction battery that provides electric power to the electric machine, and one or more controllers that, while the vehicle is parked and unplugged, selectively generate a command for a user to plug in the vehicle based on an indication of whether the vehicle is located in a shaded area.

### BRIEF DESCRIPTION OF THE DRAWINGS

FIG. 1 illustrates an example block topology of an electrified vehicle illustrating drivetrain and energy storage components.

FIG. 2 illustrates an example block topology of a vehicle system.

FIG. 3 illustrates an example flow diagram of a process for evaluating a vehicle range and operating the vehicle.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes a system and method for estimating an EV range based on temperature and operating the vehicle to charge the battery.

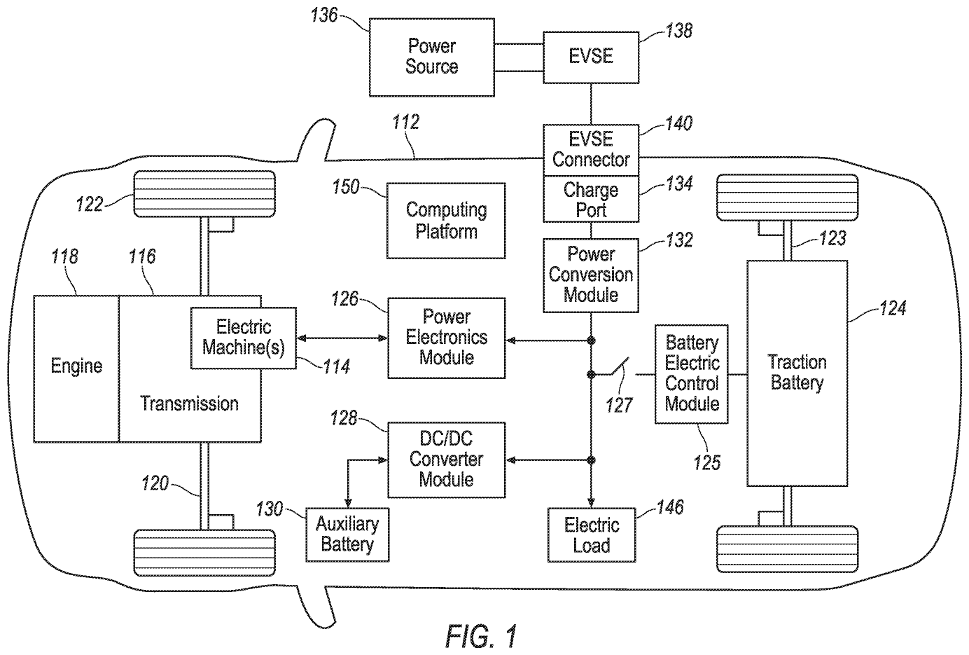

FIG. 1 illustrates a plug-in hybrid-electric vehicle (PHEV). A plug-in hybrid-electric vehicle 112 may comprise one or more electric machines (electric motors) 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft (e.g. a front drive shaft 120 or a rear drive shaft 123) that is mechanically coupled to the wheels 122. The electric machines 114 may provide propulsion and deceleration capability when the engine 118 is turned on or off. The electric machines 114 may also act as generators and may provide fuel economy benefits by recovering energy that would be lost as heat in the friction braking system. The electric machines 114 may also reduce vehicle emissions by allowing the engine 118 to operate at more efficient speeds and allowing the hybrid-electric vehicle 112 to be operated in electric mode when the engine 118 is off under certain conditions.

A traction battery or battery pack 124 stores energy that may be used by the electric machines 114. A vehicle battery pack 124 may provide a high voltage DC output. The traction battery 124 may be electrically coupled to one or more battery electric control modules (BECM) 125. The BECM 125 may be provided with one or more processors and software applications configured to monitor and control various operations of the traction battery 124. The traction battery 124 may be further electrically coupled to one or more power electronics modules 126. The power electronics module 126 may also be referred to as a power inverter. One or more contactors 127 may isolate the traction battery 124 and the BECM 125 from other components when opened and couple the traction battery 124 and the BECM 125 to other components when closed. The power electronics module 126 may also be electrically coupled to the electric machines 114 and provide the ability to bi-directionally transfer energy between the traction battery 124 and the electric machines 114. For example, a traction battery 124 may provide a DC voltage while the electric machines 114 may operate using a three-phase AC current. The power electronics module 126 may convert the DC voltage to a three-phase AC current for use by the electric machines 114. In a regenerative mode, the power electronics module 126 may convert the three-phase AC current from the electric machines 114 acting as generators to the DC voltage compatible with the traction battery 124. The description herein is equally applicable to a pure electric vehicle. For a pure electric vehicle, the hybrid transmission 116 may be a gear box connected to the electric machine 114 and the engine 118 may not be present.

In addition to providing energy for propulsion, the traction battery 124 may provide energy for other vehicle electrical systems. A vehicle may include a DC/DC converter module 128 that converts the high voltage DC output of the traction battery 124 to a low voltage DC supply that is compatible with other low-voltage vehicle loads. An output of the DC/DC converter module 128 may be electrically coupled to an auxiliary battery 130 (e.g., 12V battery).

The vehicle 112 may be a battery electric vehicle (BEV) or a plug-in hybrid electric vehicle (PHEV) in which the traction battery 124 may be recharged by an external power source 136. The external power source 136 may be a connection to an electrical outlet. The external power source 136 may be an electrical power distribution network or grid as provided by an electric utility company. The external power source 136 may be electrically coupled to electric vehicle supply equipment (EVSE) 138. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled may transfer power using a wireless inductive coupling.

One or more electrical loads 146 may be coupled to the high-voltage bus. The electrical loads 146 may have an associated controller that operates and controls the electrical loads 146 when appropriate. Examples of the electrical loads 146 may be a heating module, an air-conditioning module, or the like.

The various components discussed may have one or more associated controllers to control and monitor the operation of the components. The controllers may communicate via a serial bus (e.g., Controller Area Network (CAN)) or via discrete conductors. A computing platform 150 may be present to coordinate the operation of the various components. It is noted that the computing platform 150 is used as a general term and may include one or more controller devices configured to perform various operations in the present disclosure. The system controller 150 individually or in combination with other components of the vehicle shown or not shown, may be programmed to perform various operations of the vehicle 112.

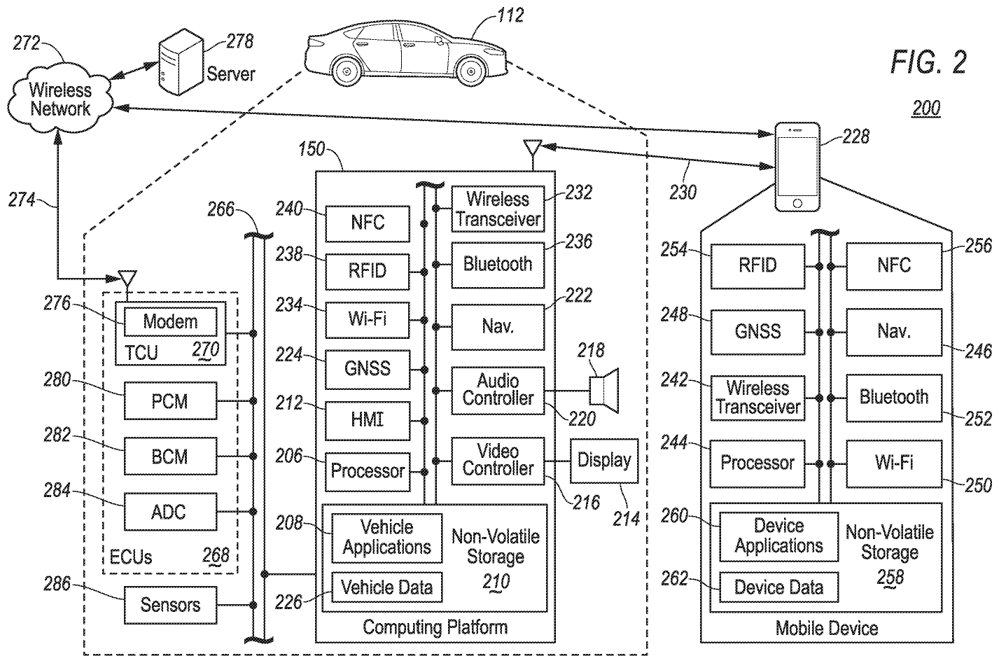

Referring to FIG. 2, an example block topology of a vehicle system 200 of one embodiment of the present disclosure is illustrated. As an example, the system 200 may include the SYNC system manufactured by The Ford Motor Company of Dearborn, Michigan. It should be noted that the illustrated system 200 is merely an example, and more, fewer, and/or differently located elements may be used.

As illustrated in FIG. 2, the computing platform 150 may include one or more processors 206 configured to perform instructions, commands, and other routines in support of the processes described herein. For instance, the computing platform 150 may be configured to execute instructions of vehicle applications 208 to provide features such as vehicle operation controls, multimedia input/output, and wireless communications. Such instructions and other data may be maintained in a non-volatile manner using a variety of types of computer-readable storage medium 210. The computer-readable medium 210 (also referred to as a processor-readable medium or storage) includes any non-transitory medium (e.g., tangible medium) that participates in providing instructions or other data that may be read by the processor 206 of the computing platform 150. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and SQL.

The computing platform 150 may be provided with various features allowing the vehicle occupants/users to interface with the computing platform 150. For example, the computing platform 150 may receive input from HMI controls 212 configured to provide for occupant interaction with the vehicle 112. As an example, the computing platform 150 may interface with one or more buttons, switches, knobs, or other HMI controls configured to invoke functions on the computing platform 150 (e.g., steering wheel audio buttons, a push-to-talk button, instrument panel controls, etc.).

The computing platform 150 may also drive or otherwise communicate with one or more displays 214 configured to provide visual output to vehicle occupants by way of a video controller 216. In some cases, the display 214 may be a touch screen further configured to receive user touch input via the video controller 216, while in other cases the display 214 may be a display only, without touch input capabilities. The computing platform 150 may also drive or otherwise communicate with one or more speakers 218 configured to provide audio output and input to vehicle occupants by way of an audio controller 220.

The computing platform 150 may also be provided with navigation and route planning features through a navigation controller 222 configured to calculate navigation routes responsive to user input via, for example, the HMI controls 212, and output planned routes and instructions via the speaker 218 and the display 214. Location data that is needed for navigation may be collected from a global navigation satellite system (GNSS) controller 224 configured to communicate with multiple satellites and calculate the location of the vehicle 112. The GNSS controller 224 may be configured to support various current and/or future global or regional location systems such as global positioning system (GPS), Galileo, Beidou, Global Navigation Satellite System (GLONASS) and the like. Map data used for route planning may be stored in the storage 210 as a part of the vehicle data 226. Navigation software may be stored in the storage 210 as one of the vehicle applications 208.

The computing platform 150 may be configured to wirelessly communicate with a mobile device 228 of the vehicle users/occupants via a wireless connection 230. The mobile device 228 may be any of various types of portable computing devices, such as cellular phones, tablet computers, wearable devices, smart watches, smart fobs, laptop computers, portable music players, or other devices capable of communication with the computing platform 150. A wireless transceiver 232 may be in communication with a Wi-Fi controller 234, a Bluetooth controller 236, a radio-frequency identification (RFID) controller 238, a near-field communication (NFC) controller 240, and other controllers such as a Zigbee transceiver, an IrDA transceiver, an ultra-wide band (UWB) controller (not shown), and be configured to communicate with a compatible wireless transceiver 242 of the mobile device 228.

The mobile device 228 may be provided with a processor 244 configured to perform instructions, commands, and other routines in support of the processes such as navigation, telephone, wireless communication, and multi-media processing. For instance, the mobile device 228 may be provided with location and navigation functions via a navigation controller 246 and a GNSS controller 248. The mobile device 228 may be provided with the wireless transceiver 242 in communication with a Wi-Fi controller 250, a Bluetooth controller 252, a RFID controller 254, an NFC controller 256, and other controllers (not shown), configured to communicate with the wireless transceiver 232 of the computing platform 150. The mobile device 228 may be further provided with a non-volatile storage 258 to store various mobile applications 260 and mobile data 262.

The computing platform 150 may be further configured to communicate with various components of the vehicle 112 via one or more in-vehicle networks 266. The in-vehicle network 266 may include, but is not limited to, one or more of a controller area network (CAN), an Ethernet network, and a media-oriented system transport (MOST), as some examples. Furthermore, the in-vehicle network 266, or portions of the in-vehicle network 266, may be a wireless network accomplished via Bluetooth low-energy (BLE), Wi-Fi, UWB, or the like.

The computing platform 150 may be configured to communicate with various electronic control units (ECUs) 268 of the vehicle 112 configured to perform various operations. The computing platform 150 may be further configured to communicate with a TCU 270 configured to control telecommunication between the vehicle 112 and a wireless network 272 through a wireless connection 274 using a modem 276. The wireless connection 274 may be in the form of various communication networks, for example, a cellular network. Through the wireless network 272, the vehicle may access one or more servers 278 to access various content for various purposes. For instance, the vehicle 112 may obtain weather data for the vehicle location from the server 278. The vehicle 112 may share the vehicle location and various sensor data (to be discussed in detail below) with the server 278. It is noted that the terms wireless network and server are used as general terms in the present disclosure and may include any computing network involving carriers, router, computers, controllers, circuitry or the like configured to store data and perform data processing functions and facilitate communication between various entities. The ECUs 268 may further include a powertrain control module (PCM) 280 configured to operate the powertrain of the vehicle 112. For instance, the PCM 280 may be configured to operate the vehicle 112 in various driving modes including a power mode in which driving performance is prioritized, an economic mode in which battery power saving is prioritized, and one or more modes between the power mode and economic mode. As an example, the PCM 280 may automatically adjust the driving mode based on a state-of-charge (SOC) of the traction battery 124 and/or vehicle range (distance to empty (DTE)).

The ECUs 268 may further include a body control module (BCM) 284 configured to control the vehicle body operation. For instance, the BCM 284 may control and adjust the activation and brightness of various exterior and interior vehicle lights. The BCM 284 may further control the vehicle heating, ventilation and air-conditioning (HVAC) system of the vehicle 112. As an example, operations of the BCM 284 may be controlled based on the SOC of the traction battery 124 or vehicle range. The ECUs 268 may further include an autonomous driving controller (ADC) 286 configured to control an autonomous driving feature of the vehicle 112. Navigation associated with the autonomous driving may be performed via the navigation controller 222 of the computing platform 150.

The vehicle 112 may be provided with various sensors 286 configured to perform various measurements to facilitate the determination of the vehicle surroundings and environment. As a few non-limiting examples, the sensors 286 may include one or more battery temperature sensors configured to provide a directly measurement of the temperature of the traction battery 124. The sensors 286 may further include one or more ambient temperature sensors configured to measure an ambient temperature and a cabin temperature of the vehicle 112. The sensors 286 may further include one or more cameras configured to capture images of the vehicle vicinity. Additionally, the cameras may be configured to support a surrounding view camera feature that captures images surrounding the vehicle 112. The sensors 286 may further include one or more radar/lidar sensors configured to detect objects within a predefined distance from the vehicle 112. The sensors 286 may further include one or more light sensor configured to measure the direction and intensity of the light received by the vehicle 112. When the vehicle 112 is parked, the sensor data may be used to determine the parking environment of the vehicle 112. For instance, the vehicle 112 may determine if the vehicle parking location is indoor or outdoor, if there is any other object nearby, and/or if the parking location is in the shade or the like.

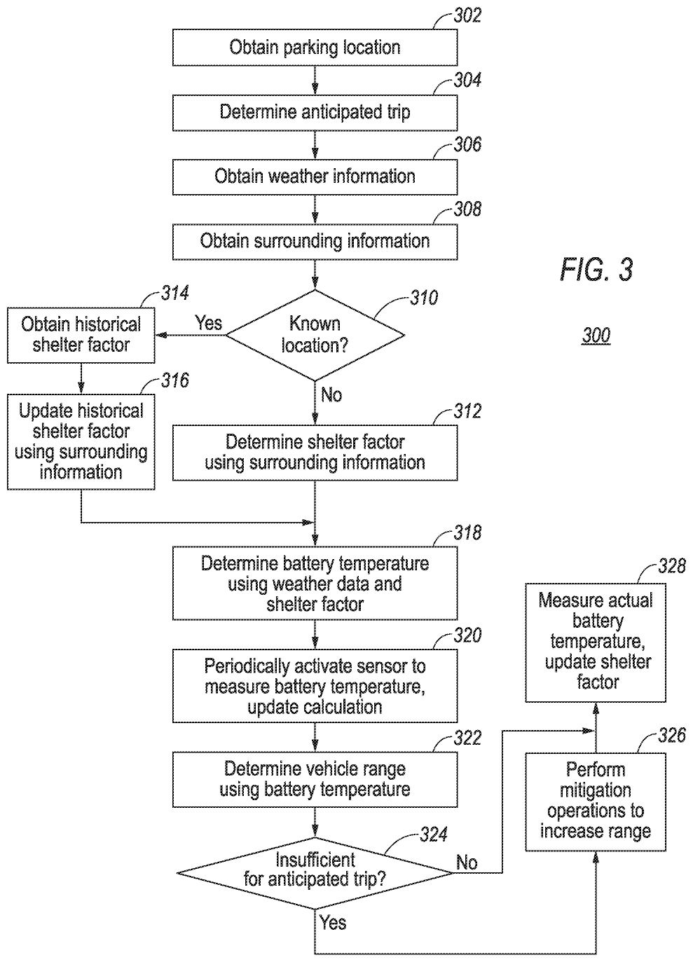

With reference to FIG. 3, a flow diagram of a process 300 for estimating the vehicle range and operating the vehicle is illustrated. With continuing reference to FIGS. 1 and 2, the process 300 may be individually or collectively implemented via one or more of the vehicle 112, the server 278 and/or the mobile device 228. For simplicity, the following description will be made with reference to the computing platform 150 and various ECUs 268 of the vehicle 112. One of the purposes of the process 300 is to provide a more accurate EV battery temperature and range estimation by considering a shelter factor that affects the battery temperature. More specifically, the shelter factor may reflect a parking condition of a general parking location that insulates the general ambient temperature of the area and the battery temperature. For instance, the shelter factor may be affected by whether the vehicle is parked indoor or outdoor, existence of buildings or plants blocking wind or creating shade, ground material or the like.

At operation 302, responsive to detecting the vehicle has parked, the computing platform 150 obtains a parking location of the vehicle 112 via the GNSS controller 224. Additionally or alternatively, the computing platform 150 may use the location data from the mobile device 228 to determine the parking location. At operation 304, the computing platform 104 determines an anticipated trip immediately after the current parking event. The anticipated trip may include a predicted departure time indicative of the time in the future when the vehicle 112 starts to be used and a destination at a distance from the current parking location. Therefore, with the trip anticipated, the computing platform 150 may determine an anticipated parking duration at the current location and a predicted amount of energy required to complete the trip. There are a variety of methods to determine the anticipated trip. For instance, the computing platform 150 may be granted access to a user calendar having one or more entries with time and location. Additionally or alternatively, the computing platform 150 may use the historical trip data of the vehicle 112 to determine the anticipated trip. At operation 306, the computing platform 150 obtains weather information for the parking duration from the server 278. The weather information may include a predicted ambient temperature at the area at the departure time when the vehicle 112 is scheduled to start the anticipated trip to allow the computing platform 150 to calculate the battery temperature that is correlated to the ambient temperature of the area where the vehicle 112 is parked. When the battery temperature is within a temperature range, optimal performance and range may be achieved. However, the battery temperature may be outside the range due to the weather which affects the range of the vehicle. In general, the battery temperature may be affected by the ambient temperature of the vehicle 112. However, vehicles parked at the same general area may encounter significantly different vehicle battery temperature due to the specific condition of the parking spot even if the vehicle shares the same ambient temperature in the area. For instance, vehicles parked directly under sunshine may have a higher battery temperature compared to vehicles parked in shade. In the winter, vehicles parked in a garage attached to a house may generally have a higher battery temperature compared with vehicles parked in an unattached garage or outdoors. In addition, building structures and/or other vehicles may block wind for the vehicles at issue in a windy day, further affecting the battery temperature. The specific parking condition of the vehicle 112 may be characterized as a shelter factor by the computing platform 150 used to calculate the battery temperature at the departure time.

At operation 308, the computing platform 150 obtains the parking condition surrounding the vehicle 112 in order to determine the shelter factor. As discussed above, the vehicle 112 may be provided with various sensors 286 configured to measure and evaluate the parking surrounding conditions of the vehicle 112. For instance, the proximity sensors and cameras 286 may be used to detect if there are any building structures or vehicles near the vehicle 112. The light sensors 286 may be used to measure the direction and intensity of sunlight received by the vehicle 112. Additionally, the computing platform 150 may obtain the surrounding information from the server 278 via the TCU 270. For instance, 3D map data from the server 278 may indicate one or more buildings are located near the parking location and the vehicle 112 will be in shade of the buildings at a predefined time overlapping the parking duration. At operation 310, the computing platform 150 verifies if the current parking location is a known location by the system. Here, the known location may include one or more locations that the vehicle 112 has previously been parked at (e.g. home garage, office parking lot). Additionally or alternatively, the known location may include one or more locations that a fleet vehicle shares data with vehicle 112 in a crowdsourced manner. If the computing platform 150 determines the current parking location is unknown, the process proceeds to operation 312 and the computing platform 150 determines the shelter factor using the surrounding information obtained at operation 308. As discussed above, the shelter factor may characterize an isolating effect between the temperature of the weather report and the predicted battery temperature. The shelter factor may be adjusted in response to objects or conditions that affect the vehicle battery temperature from reaching the forecasted temperature in the area. As a few non-limiting examples, objects and conditions may include an indoor parking structure (e.g. garage), buildings, plants or other vehicles blocking wind to the vehicle 112. Objects and conditions may further include buildings, plant or other vehicles creating shade covering the parking location of the vehicle 112. Objects and conditions may further include a direct sunshine condition increasing the vehicle temperature. Objects and conditions may further include concrete parking ground material that collects heat or the like. If the computing platform 150 determines that the current parking location is known to the system, the process proceeds to operation 314 and the computing platform 150 obtains a historical shelter factor corresponding to the parking location of the vehicle 112. Here, the historical shelter factor may be locally obtained from the storage 210 as the vehicle data 226 and/or remotely obtained from the server 278 contributed by one or more fleet vehicles. In some situations, the historical shelter factor may not fully reflect the surrounding condition of the vehicle parking location due to factors such as minor deviation of the parking location, condition of trees in different seasons (e.g. presence of leaves), new building structures, or presence of other vehicles near the vehicle 112. At operation 316, the computing platform 150 verifies the historical shelter factor and performs updates to the historical shelter factor using the surrounding information if needed.

With the shelter factor determined, at operation 318, the computing platform 150 determines the predicted battery temperature at the time of the departure using the weather data, the shelter factor as well as various other factors. In an example, the predicted battery temperature may be calculated as a function of the predicted weather temperature, battery temperature when the vehicle is parked, predicted parking duration and the shelter factor as presented in the following equation:

T_{predicted_batt}=f(T_{weather},Tₚₐᵣₖ,t_{parking},Shelter_factor)

At operation 320, while the vehicle 112 is parked, the computing platform 150 periodically activates the vehicle sensors 286 to collect various data such as the battery temperature at different times during the parking duration and compares the data with the temperature prediction to identify any significant deviation. Responsive to the deviation being greater than a threshold, the computing platform 150 may recalculate the shelter factor and the predicted battery temperature at departure time accordingly. At operation 322, the computing platform 150 calculates the vehicle range based on the predicted temperature at the departure time. At operation 324, the computing platform 150 verifies if the vehicle range is sufficient for the anticipated trip determined at operation 304. In an example, the computing platform 150 may directly compare the vehicle range with the route distance of the anticipated trip. Alternatively, a margin (e.g. additional 10 miles, or 10% of the vehicle range) may be added into the comparison to provide a more robust mechanism. If the computing platform 150 determines the vehicle range is insufficient to satisfy the anticipated trip, the process proceeds to operation 326 and computing platform 150 performs mitigation operations to increase the vehicle range. As a few non-limiting examples, the computing platform 150 may generate and send a message to the mobile device 128 of the vehicle user to ask to charge the battery before the anticipated trip. Additionally or alternatively, the vehicle 112 may autonomously drive to a charging location via the ADC 284 to charge the battery 124 and return to the parking location before the anticipated departure time. Additionally or alternatively, the ECUs 268 of the vehicle may switch to one or more power saving modes to reduce the power consumption while the vehicle is being driven such that the range of the vehicle is increased. For instance, the PCM 280 may enter the economic mode and prohibit the user to switch to the power mode. The BCM 282 may reduce the intensity of vehicle light and limit HVAC operations to conserve electric energy. Additionally or alternatively, the computing platform 150 may further limit power of accessory device that is non-essential for the driving of the vehicle (e.g. entertainment features, HVAC or the like). Additionally or alternatively, the computing platform 150 may send a message to the mobile device 228 to inform the user about the situation and ask the user to select from one of the mitigation actions discussed above. At operation 328, the computing platform 150 measures the actual battery temperature during the parking duration and updates the shelter factor at the parking location by comparing the actual battery temperature with the predicted temperature.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

1. A power system for a vehicle comprising:
one or more controllers programmed to
limit power consumption of at least one accessory load during an upcoming trip responsive to a predicted electric travel range of the vehicle being less than a predicted distance for the trip, wherein the predicted electric travel range is based on an indication of whether the vehicle is parked in a sheltered location or an unsheltered location.

2. The power system of claim 1 further comprising one or more sensor arrangements configured to detect whether the vehicle is located adjacent to or within a structure, wherein the indication is based on whether the vehicle is located adjacent to or within a structure.

3. The power system of claim 1 further comprising one or more sensor arrangements configured to detect whether the vehicle is located in a shaded area, wherein the indication is based on whether the vehicle is located in a shaded area.

4. The power system of claim 1, wherein the one or more controllers are further programmed to generate a user alert to plug in the vehicle responsive to the predicted electric travel range being less than the predicted distance and the vehicle being unplugged.

5. The power system of claim 1, wherein the one or more controllers are further programmed to generate output for display indicative of the predicted electric travel range.

6. The power system of claim 1, wherein the predicted electric travel range is further based on a predicted departure time of the upcoming trip.

7. The power system of claim 6, wherein the predicted electric travel range is further based on predicted weather information for the predicted departure time.

8. A method for a vehicle, comprising:
while the vehicle is parked and unplugged, selectively generating a command for a user to plug in the vehicle based on an indication of whether the vehicle is located in a shaded area.

9. The method of claim 8, wherein the selectively generating is further based on an indication of a degree to which the vehicle is located adjacent to or within a structure.

10. The method of claim 8, wherein the selectively generating is further based on a predicted travel range being less than a predicted distance for an upcoming trip.

11. The method of claim 8, wherein the selectively generating is further based on a predicted departure time for a predicted upcoming trip.

12. The method of claim 8 further comprising limiting power consumption of at least one accessory load during an upcoming trip.

13. A vehicle comprising:
an electric machine;
a traction battery configured to provide electric power to the electric machine; and
one or more controllers programmed to, while the vehicle is parked and unplugged, selectively generate a command for a user to plug in the vehicle based on an indication of whether the vehicle is located in a shaded area.

14. The vehicle of claim 13, wherein the one or more controllers are further programmed to limit power consumption of at least one accessory load during an upcoming trip based on the indication.

15. The vehicle of claim 13, wherein the one or more controllers are further programmed to generate the command based on an indication of a degree to which the vehicle is located adjacent to or within a structure.

16. The vehicle of claim 13, wherein the one or more controllers are further programmed to selectively generate the command based on a predicted departure time of an upcoming trip.

17. The vehicle of claim 13, wherein the one or more controllers are further programmed to selectively generate the command based on a predicted distance of an upcoming trip.

18. The vehicle of claim 13, wherein the one or more controllers are further programmed to generate output for display indicative of an electric travel range of the vehicle.

19. The power system of claim 1, wherein the predicted travel range is further based on ambient temperature.
